(19) United States
(12) Patent Application Publication
(10) Pub. No.: US 2006/0087609 A1
(43) Pub. Date: Apr. 27, 2006

(54) Liquid crystal display device

(75) Inventor: Daniel Lee, Gueishan Township (TW)

Correspondence Address: BACON & THOMAS, PLLC, 625 SLATERS LANE, FOURTH FLOOR, ALEXANDRIA, VA, 22314, US

(73) Assignee: Quanta Display Inc., Kuei Shan Hsiang (TW)

(21) Appl. No.: 11/194,662

(22) Filed: Aug. 2, 2005

(30) Foreign Application Priority Data
Oct. 26, 2004 (TW) 093132416

(51) Int. Cl. G02F 1/1343

(52) U.S. Cl. 349/139

(57) ABSTRACT

A liquid crystal display device is disclosed, which has a first substrate, a second substrate and a liquid crystal layer. The second substrate includes pixel electrodes, first electrically conductive lines, electrically conductive lines, common wires, switch elements, and a dielectric layer. First electrically conductive lines intersect with common wires on the second substrate. The first electrically conductive lines outside of an intersection area are sandwiched between pixel electrodes and the second substrate and covered by the projection of the pixel electrodes on the second substrate. A switch element connects with the first and second electrically conductive lines. Moreover, a dielectric layer sandwiched between the pixel electrodes and the second substrate covers the first electrically conductive lines, the common wires, and the second electrically conductive lines. Therefore, the liquid crystal display device can prevent non-uniform brightness due to different levels of parasitic capacitance.

### TECHNICAL FIELD

The present invention relates to a flat panel display device and, more particularly, to a liquid crystal display device.

### BACKGROUND OF THE INVENTION

The liquid crystal display device can be divided into two categories, i.e. passively driven and actively driven liquid crystal display devices, according to their driving manners. The passively driven liquid crystal display device has an array of scan electrodes and data electrodes. Owing to the synchronous scanning signals, the liquid crystal in each pixel can be driven by the external voltage. However, as the density of the pixel increases, the scanning lines will increase, which leads to the decrease of display contrast. As for the actively driven liquid crystal display device, it utilizes the thin-film transistor or the metal diode to switch on or off the pixels in a scanning manner. Therefore, an excellent image quality and resolution could be obtained.

Conventionally, as shown in FIG. 1a, the data line 60 of the liquid crystal display device is formed below the pixel electrode 3. Although the parasitic capacitances will be caused between the data lines 60 and the pixel electrodes 3, the parasitic capacitances are the same as if the adjacent pixel electrodes 3 equally overlap the data lines 60 in vertical projection direction respectively with equal areas. Therefore, the voltages supplied to each of the pixels are still the same, and the brightness of each pixel should be uniform. However, the overlapped areas of the data lines 60 and the pixel electrodes 3 are usually different due to the misalignment of the process, especially in exposure process, as shown in FIG. 1b. As a result, different parasitic capacitances are formed. As the voltages of display electrodes are affected improperly by the parasitic capacitances, a Mura phenomenon will appear, and the quality of display image deteriorates.

### SUMMARY OF THE INVENTION

In order to improve the aforementioned disadvantages of the conventional liquid crystal display device, the present invention provides a novel liquid crystal display device. The liquid crystal display device of the present invention includes a first substrate, a second substrate and a liquid crystal layer sandwiched between the first substrate and the second substrate. The second substrate has a plurality of pixel electrodes, a plurality of first electrically conductive lines, a plurality of second electrically conductive lines, a plurality of common wires, a plurality of switch elements, and a dielectric layer. The first electrically conductive lines intersect with the common wires in an intersection area. The first electrically conductive lines outside of the intersection area are sandwiched between the pixel electrodes and the second substrate and covered by the projection of the pixel electrodes on the second substrate. Moreover, the switch element connects with both the first and second electrically conductive lines. The dielectric layer formed between the pixel electrodes and the second substrate covers the first electrically conductive lines, the common wires, and the second electrically conductive lines. Therefore, the parasitic capacitances produced in the liquid crystal display of the present invention will be the same, and thus the non-uniform brightness caused by the difference of parasitic capacitances can be prevented.

The first electrically conductive lines and the second electrically conductive lines of the liquid crystal display device of the present invention can be arranged arbitrarily. Preferably, the first electrically conductive lines are perpendicular to the second electrically conductive lines. The second electrically conductive lines and the common wires of the liquid crystal display device of the present invention can also be arranged arbitrarily. Preferably, the second electrically conductive lines are parallel to the common wires. The first electrically conductive lines of the liquid crystal display device of the present invention are covered by the projection of the pixel electrodes. Preferably, each of the first electrically conductive lines is covered by a pair of adjacent pixel electrodes. The areas of the first electrically conductive lines covered respectively by the adjacent pixel electrodes are not restricted. Preferably, the adjacent pixel electrodes cover the first electrically conductive lines in the same length or the same area.

A plurality of third electrically conductive lines can further be formed in the liquid crystal display device of the present invention. The projection of the third electrically conductive lines on the second substrate overlaps the projection of the gap between the adjacent pixel electrodes on the second substrate. Preferably, the area of the projection of the third electrically conductive lines is larger than that of the projection of the gap between the adjacent pixel electrodes. The third electrically conductive lines can be made of any usable materials. Preferably, the third electrically conductive lines are made of chromium or electrically conductive materials having light-shield capability. Consequently, the liquid crystal display device of the present invention has one more electrically conductive line to aid the transmission of current without shrinking light-transmittance area.

The pixel electrodes of the liquid crystal display device of the present invention can be arranged in a matrix or other arrangement. The switch element of the present invention can be a thin-film transistor or other equivalent switch element. The common wire can be made of indium tin oxide (ITO), indium zinc oxide (IZO), or any conventional electrically conductive materials. Furthermore, the first substrate and the second substrate can be made of glass or any conventional materials.

### BRIEF DESCRIPTION OF THE DRAWINGS

FIG. 1a˜1b show the cross-sectional views of the conventional liquid crystal display device;

FIG. 2 shows the top view of the preferred embodiment of the present invention; and

FIG. 3 is the cross-sectional view of FIG. 2.

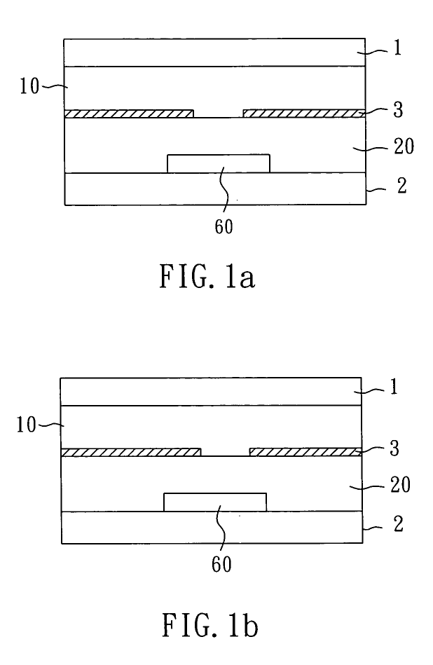

### DETAILED DESCRIPTION OF THE PREFERRED EMBODIMENTS

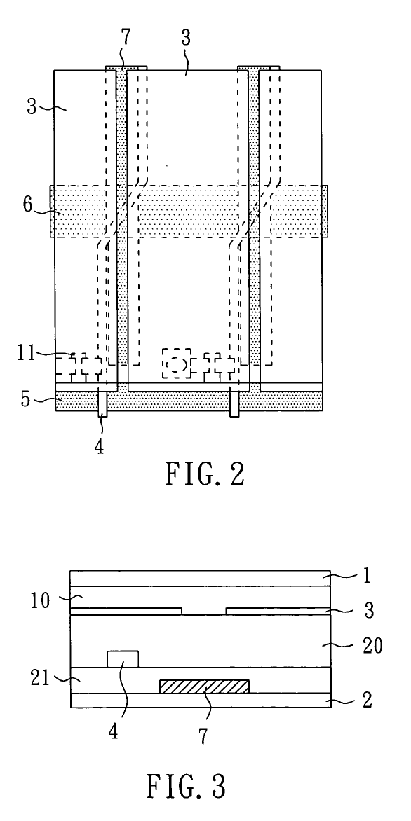

With reference to FIG. 2 and FIG. 3, FIG. 2 shows the top view of the preferred embodiment of the present invention, and FIG. 3 is the cross-sectional view of FIG. 2. The liquid crystal display device of the present embodiment includes a first substrate 1, a second substrate 2, and a liquid crystal layer 10 sandwiched between the first substrate 1 and the second substrate 2. The second substrate 2 has a plurality of pixel electrodes 3, a plurality of first electrically conductive lines 4, a plurality of second electrically conductive lines 5, a plurality of common wires 6, a plurality of third electrically conductive lines 7, a plurality of thin-film transistors 11, and a dielectric layer 20. The pixel electrodes of the present embodiment are arranged to form an array. The first electrically conductive lines 4 of the present embodiment are data lines that transmit data voltages to the source electrodes of the thin-film transistors 11. The second electrically conductive lines 5 are scan lines that transmit scanning signals to the gate electrodes of the thin-film transistors 11. The third electrically conductive lines 7 serve as an auxiliary capacitance wire, and the common wires are located below the pixel electrodes 3. The first electrically conductive lines 4 are formed approximately along the edge of the pixel electrode 3, but intersect the adjacent pixel electrode at the middle area of the pixel electrodes 3. As for the first electrically conductive lines 4 outside of the intersection area, they are almost covered by the projection of the pixel electrodes 3. The dielectric layer 20 is sandwiched between the pixel electrodes 3 and the first electrically conductive lines 4. On the second substrate 2, the first electrically conductive lines 4 are perpendicular to the second electrically conductive lines 5, the second electrically conductive lines 5 are parallel to the common wires 6, and the thin-film transistor (TFT) 11 connects to the first electrically conductive lines 4 and the second electrically conductive lines 5. However, in order to solve the misalignment between the data lines and the pixel electrodes, the first electrically conductive lines on the second substrate of the present invention intersect with the common wires 6. Each of the first electrically conductive lines 4 outside of the intersection area is located between the second substrate 2 and the pixel electrodes and is covered by the adjacent pixel electrodes 3. In addition, the areas in the first electrically conductive lines 4 covered by adjacent pixel electrodes 3 are the same. Therefore, as shown in FIG. 3, the first electrically conductive lines 4 of the liquid crystal display device of the present invention are equally covered by the adjacent pixel electrodes, thereby the parasitic capacitances caused in each pixel electrode are the same. Consequently, each pixel has the same brightness. By equally covering the data lines with the adjacent pixel electrodes except the intersection area, the present invention minimizes the difference of parasitic capacitance caused by the misalignment of data lines and the pixel electrodes. Therefore, the difference between voltages of adjacent pixel electrodes is minimized to produce a uniform brightness. Such an effect is especially outstanding when the adjacent pixel electrodes respectively overlap the data lines in the same area and length.

Moreover, the third electrically conductive lines 7 are made of light-shield materials. The projection of the third electrically conductive lines 7 on the second substrate 2 overlaps the projection of the gap between adjacent pixel electrodes 3, or the area of the projection of the third electrically conductive lines 7 is even larger than that of the projection of the gap between adjacent pixel electrodes 3. As a result, the third electrically conductive lines 7 also serve as a black light-shielding layer for the gap between the pixel electrodes 3. Additionally, the third electrically conductive lines 7 will not reduce the light transmittance area. Consequently, the liquid crystal display device of the present invention not only has one more current-transmittance wire, but also keeps the same aperture ratio as the conventional liquid crystal display device.

Besides, the dielectric layers 20, 21 are sandwiched between the second substrate 2 and the pixel electrodes 3, and all the first electrically conductive lines 4, the common wires 6, the second electrically conductive lines 5, and the third electrically conductive lines 7 are covered by the dielectric layers 20, 21. In the present embodiment, the common wires 6 can be made of indium tin oxide (ITO) or indium zinc oxide (IZO), and the first substrate 1 and the second substrate 2 are made of glass.

The above detailed description is given by way of example and not intended to limit the invention solely to the embodiments described herein.

1. A liquid crystal display device, comprising:
a first substrate;
a second substrate having a plurality of pixel electrodes, a plurality of first electrically conductive lines, a plurality of second electrically conductive lines, a plurality of common wires, a plurality of switch elements, and a dielectric layer; wherein the projection of the common wires on the second substrate intersects with the projection of the first electrically conductive lines on the second substrate in an intersection area, the switch element connects with the first electrically conductive lines and the second electrically conductive lines, the dielectric layer is formed between the second substrate and the pixel electrode, and all the first electrically conductive lines, the common wires, and the second electrically conductive lines are covered by the dielectric layer; and
a liquid crystal layer sandwiched between the first substrate and the second substrate;
wherein the first electrically conductive lines outside of the intersection area are sandwiched between the second substrate and the pixel electrodes and covered by a projection of the pixel electrodes on the second substrate.

2. The liquid crystal display device as claimed in claim 1, wherein the second electrically conductive lines are perpendicular to the first electrically conductive lines.

3. The liquid crystal display device as claimed in claim 1, wherein second electrically conductive lines are parallel to the common wires.

4. The liquid crystal display device as claimed in claim 1, wherein each of the first electrically conductive lines is covered by the adjacent pixel electrodes.

5. The liquid crystal display device as claimed in claim 4, wherein the adjacent pixel electrodes cover the first electrically conductive line respectively in equal length or area.

6. The liquid crystal display device as claimed in claim 1, further comprising a plurality of third electrically conductive lines formed on the second substrate sandwiched between the second substrate and the adjacent pixel electrodes, wherein a projection of the third electrically conductive lines on the second substrate overlaps the projection of the adjacent pixel electrodes on the second substrate.

7. The liquid crystal display device as claimed in claim 6, wherein a width of the projection of the third electrically conductive line on the second substrate is wider than a width of the projection of a gap between the adjacent pixel electrodes on the second substrate.

8. The liquid crystal display device as claimed in claim 7, wherein the third electrically conductive lines are made of light-shield materials.

9. The liquid crystal display device as claimed in claim 1, wherein the switch element is a thin-film transistor (TFT).

10. The liquid crystal display device as claimed in claim 1, wherein both the first substrate and the second substrate are made of glass.
